(19) United States
(12) Patent Application Publication
(10) Pub. No.: US 2007/0216838 A1
(43) Pub. Date: Sep. 20, 2007

(54) Multi-domain vertical alignment liquid crystal display

(76) Inventors: Cheming Hsu, Tainan (TW); Mingfeng Hsieh, Tainan (TW); Chihyung Hsieh, Tainan (TW); Chienhong Chen, Tainan (TW); Yingren Chen, Tainan (TW)

Correspondence Address: TROP PRUNER & HU, PC, 1616 S. VOSS ROAD, SUITE 750, HOUSTON, TX, 77057-2631, US

(21) Appl. No.: 11/717,330

(22) Filed: Mar. 13, 2007

(30) Foreign Application Priority Data
Mar. 14, 2006 (TW) 095108517

(51) Int. Cl. G02F 1/1337

(52) U.S. Cl. 349/129; 349/130

(57) ABSTRACT

A multi-domain vertical alignment liquid crystal display panel includes an active element array substrate, an opposite substrate, and a liquid crystal layer disposed between the two substrates. The active element array substrate has a plurality of pixel units. Each pixel unit includes an active element and a pixel electrode that is electrically connected to the active element. The opposite substrate has a common electrode layer formed thereon. The pixel electrode, the common electrode layer, or both have a plurality of alignment branches formed thereon. The alignment branches are arranged to face each other to form jagged slits. At least one pair of facing alignment branches is different from the other facing alignment branches.

### CROSS-REFERENCE TO RELATED APPLICATION

This claims priority under 35 U.S.C. § 119 of Taiwan Application No. 095108517, filed Mar. 14, 2006.

### TECHNICAL FIELD

This invention relates to a display, and more particularly, to a multi-domain vertical alignment liquid crystal display.

### BACKGROUND

The ever-increasing demand for displays has motivated display manufacturers to develop various types of displays. The cathode ray tube (CRT) display, in particular, has long dominated the display market. However, because of high power consumption and high radiation emission of CRT displays, other types of displays, such as the thin film transistor liquid crystal display (TFT-LCD), have become more popular. TFT-LCDs have the advantages of providing high display quality, space efficiency, low power consumption, and no radiation emission.

Generally, LCDs exhibit high contrast ratio, no gray scale inversion, small color shift, high luminance, excellent color richness, high color saturation, quick response, and wide viewing angle. Example types of LCDs that are able to provide wide viewing angles include the following: twisted nematic LCDs with wide viewing film, in-plane switching (IPS) LCDs, fringe field switching LCDs, and multi-domain vertical alignment (MVA) LCDs.

A conventional MVA LCD panel includes an active element array substrate, an opposite substrate and a liquid crystal layer sandwiched between the active element array substrate and the opposite substrate. As is shown in FIG. 1A, the active element array substrate 101 of the conventional MVA LCD panel includes a pixel electrode 110. The pixel electrode 110 has a plurality of main slits 112 and a plurality of fine slits 114. A common electrode layer 120 on the opposite substrate 102 (FIG. 1B) of the conventional MVA LCD panel also has a plurality of main slits 122 and a plurality of fine slits 124. The direction of an electric field near the main slits 112, 122 and the fine slits 114, 124 can be different from that of other regions in the pixel. Thus, the liquid crystal molecules (not shown) sandwiched between the active element array substrate 101 and the opposite substrate 102 may be aligned in multiple directions and produce several different alignment domains.

Referring to FIG. 1C, singular points S may occur when the conventional MVA LCD panel 100 displays images. Generally, the singular points S occur when the liquid crystal molecules in the liquid crystal layer (not shown) adjacent a portion of the main slits 112 and the fine slits 114 align randomly in uncertain directions due to lack of sufficient guiding force. The number and positions of the singular points S, however, are not predictable. Furthermore, the number and positions of the singular points S may differ from pixel region to pixel region, which can result in different displaying qualities in various pixel regions. In turn, this can adversely affect the displaying quality of the MVA LCD panel 100.

### BRIEF DESCRIPTION OF THE DRAWINGS

FIG. 1A is a schematic view of an active element array substrate on a conventional multi-domain vertical alignment liquid crystal display panel.

FIG. 1B is a schematic view of an opposite substrate of a conventional multi-domain vertical alignment liquid crystal display panel.

FIG. 1C is a schematic view of a conventional multi-domain vertical alignment liquid crystal display panel.

FIG. 2 is a partial sectional view of a multi-domain vertical alignment (MVA) liquid crystal display (LCD) panel according to an embodiment.

FIG. 3A is a schematic view of an active element array substrate of multi-domain vertical alignment liquid crystal display panel according to some embodiments.

FIG. 3B is a schematic view of an opposite substrate according to some embodiments.

FIG. 4A is a schematic view of a pixel electrode in region R of FIG. 3A.

FIGS. 4B-4E are schematic views of alternatives to the region R shown in FIG. 4A according to some embodiments.

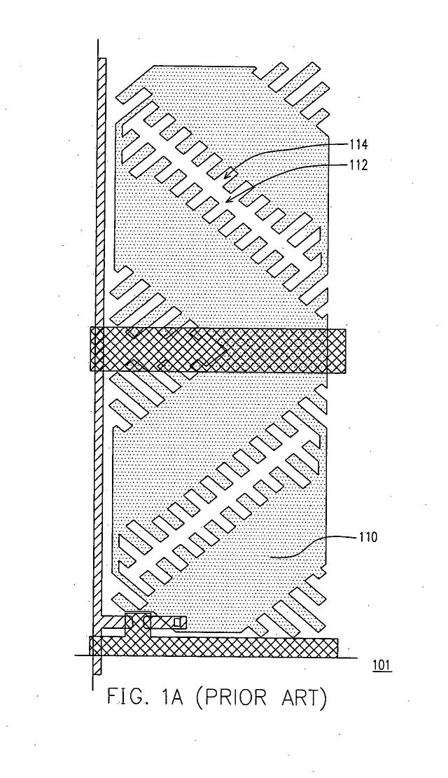

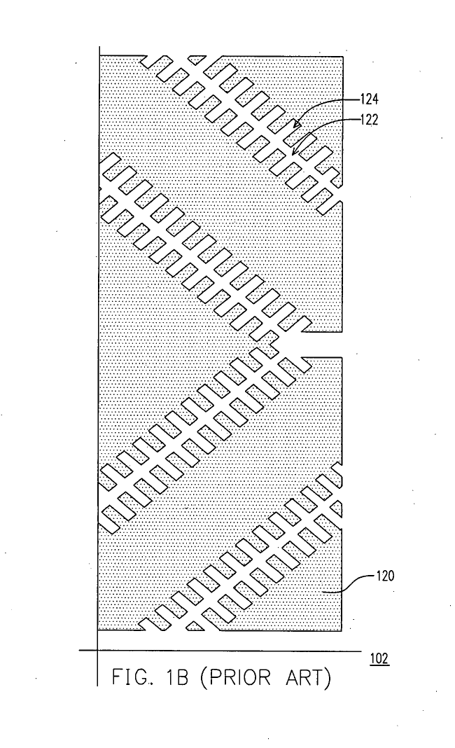

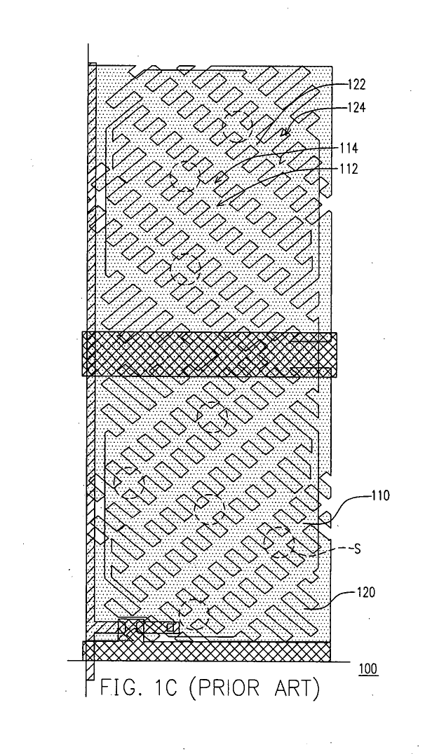

### DETAILED DESCRIPTION

A multi-domain vertical alignment (MVA) liquid crystal display (LCD) panel typically has an active element array substrate, an opposite substrate, and a liquid crystal layer sandwiched between the two substrates. The active element array substrate can have a plurality of pixel units disposed thereon. Generally, each pixel unit includes an active element and a pixel electrode electrically connected to the active element. In some embodiments of the present invention, the pixel electrode includes a plurality of alignment branches. A subset of these alignment branches face each other to form jagged slits. The design of one pair of facing alignment branches can differ from the design of other pairs of facing alignment branches.

In some embodiments, the opposite substrate has a common electrode layer disposed thereon. The common electrode layer may include a plurality of alignment branches that are similar to those formed on the pixel electrode. For example, a subset of alignment branches on the common electrode layer may face each other and they may be arranged to form jagged slits. The design of one pair of facing alignment branches on the common electrode layer can differ from the design of other pairs of facing alignment branches on this layer.

The pair of alignment branches on the common electrode layer and/or pixel electrode that have a different design may affect the position in which singular points S occur. For instance, the tilting state of liquid crystal molecules can be controlled by the electric field distribution at the differently designed alignment branches. Additionally, the number of singular points S can be controlled by forming adjacent pairs of differently designed alignment branches a predetermined distance from each other. Because the arrangement of the differently designed alignment branches may affect the number and/or the position of singular points S, the display quality of the MVA LCD panel may be enhanced.

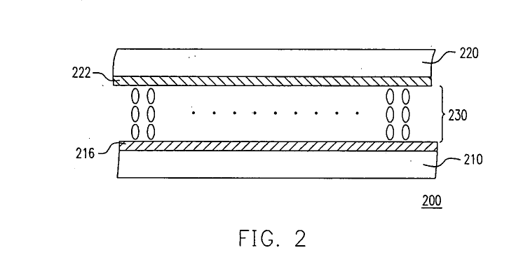

Referring to FIG. 2, an embodiment of a multi-domain vertical alignment liquid crystal display panel 200 is depicted. The MVA LCD 200 includes an active element array substrate 210, an opposite substrate 220, and a liquid crystal layer 230. A pixel electrode 216 is formed on the active element array substrate 210 and a common electrode layer 222 is formed on the opposite substrate 220. In some embodiments, the opposite substrate 220 is a color filter substrate although embodiments are not limited thereto. The liquid crystal layer 230 is sandwiched between the active element array substrate 210 and the opposite substrate 220, for example, between the pixel electrode 216 and the common electrode layer 222.

The common electrode layer 222 may be electrically connected to a stable voltage source (not shown). When a voltage is applied between the pixel electrode 216 and the common electrode layer 222, the alignment state of the liquid crystal molecules in the liquid crystal layer 230 changes from vertical (shown) to tilted (not shown). In other words, the electric field distribution between the pixel electrode 216 and a common electrode layer 222 causes the liquid crystal molecules to rotate. In some embodiments, the pixel electrode 216 on the active element array substrate 210 is patterned to form various shapes, which causes the electric field distribution to change. In other embodiments, the common electrode layer 222 on the opposite substrate 220 is patterned to form various shapes. This too can cause the electric field distribution to change. In yet other embodiments, both the pixel electrode and the common electrode layer are patterned.

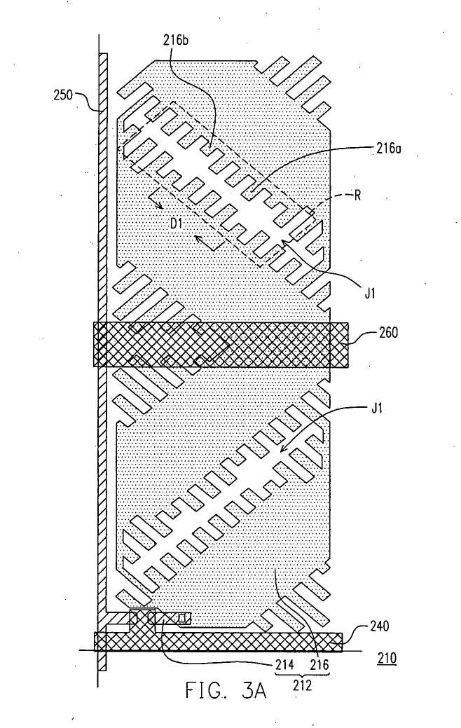

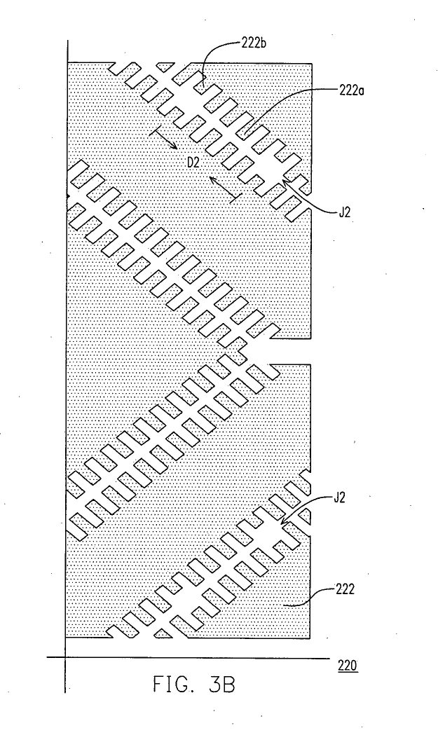

An exemplary patterned pixel electrode 216 is shown in FIG. 3A. The pixel electrode 216 is electrically connected to an active element 214. A pixel unit 212 includes the pixel electrode 216 and the active element 214. The pixel unit 212 is on the active element array substrate 210. Although only one pixel unit 212 is illustrated in FIG. 3A, the active element array substrate 210 includes a plurality of pixel units. In some embodiments, the active element 214 may be a thin-film transistor although embodiments are not so limited; the active element may be any other suitable switching element. Furthermore, in some embodiments, a common line 260 can be provided on the active element array substrate 210 to form a pixel storage capacitor in an individual pixel region. Generally, a turn-on signal may be transmitted to the active element 214 through the scan line 240 to control the switching state of the active element 214 to determine whether or not the pixel electrode 216 is charged. A data signal is written in the pixel electrode 216 via the active element 214 by the data line 250 after the active element 214 has been turned on.

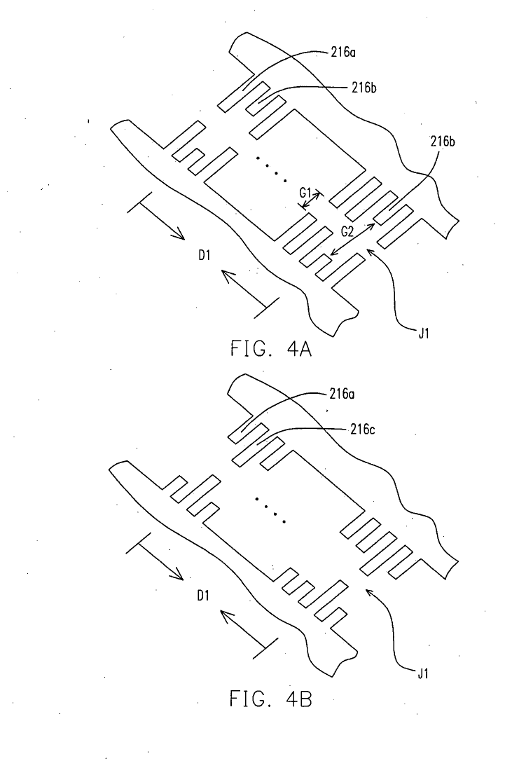

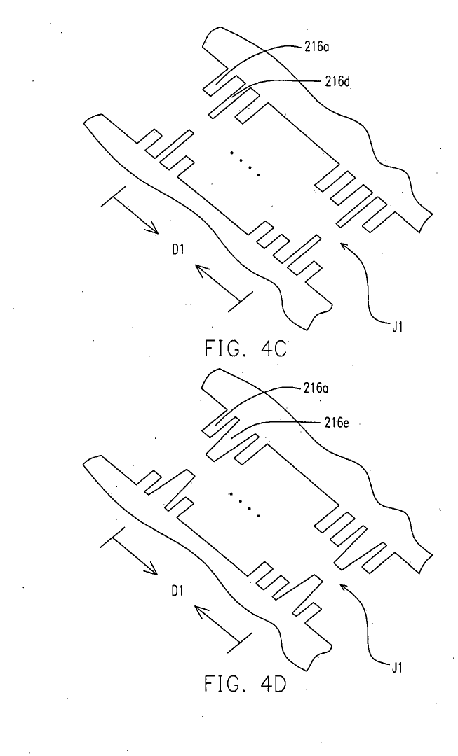

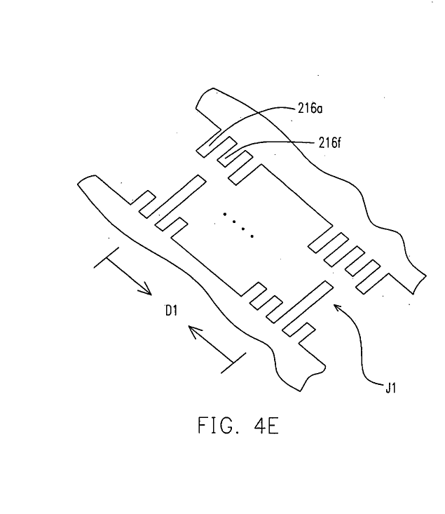

A region R of the pixel electrode 216 is shown in FIGS. 3A and 4A; the region R shown in FIG. 4A being in an enlarged view. Referring to FIGS. 3A and 4A, a plurality of first alignment branches 216a are formed in the region R. In some embodiments, the first alignment branches 216a may be generally rectangular where one side of the rectangle is integral with the pixel electrode 216. Moreover, the first alignment branches 216a can face each other to form jagged slits J1. Notably, embodiments are not limited to pixel electrodes having the generally rectangular alignment branches shown in FIGS. 3A and 4A. That is, the first alignment branches 216a may have another shape and/or dimensions. At least one pair of the first alignment branches in region R may differ in shape and/or dimensions as compared to other first alignment branches in this region. For example, the first alignment branches 216b are shorter than the first alignment branches 216a. In some embodiments, adjacent pairs of shorter first alignment branches 216b may be separated by a first predetermined distance D1. The position, number, and shape/dimensions of the first alignment branches 216b are not limited to that shown in FIGS. 3A and 4A; they can be varied according to various requirements.

The arrangement of the differently formed first alignment branches 216b, which in this example are shorter than the first alignment branches 216a, may effectively control the location where singular points S occur. For example, referring to FIG. 4A, a gap may separate facing pairs of first alignment branches. The gap at G1 is different (narrower) than the gap at G2 (wider). This is because a pair of first alignment branches 216a is separated at G1 and a pair of first alignment branches 216b is separated at G2. Because the gap at G1 and G2 is different, the electric field distribution at the first alignment branches 216b may be different from the electric field distribution at other regions. The difference in electric field distribution at the first alignment branches 216b may effectively guide the liquid crystal molecules in the liquid crystal layer 230 in the region of the first alignment branches 216b along a predetermined direction to align in the same direction. Thus, the multi-domain vertical alignment liquid crystal display panel 200 may display singular points S in positions corresponding to the different (e.g., shorter) first alignment branches 216b. If two singular points S are located in positions corresponding to the first alignment branches 216b separated by distance D1, a third singular point S cannot easily occur between the two. This is because the cell gap between the active element array substrate 210 and the opposite substrate 220 is limited, and liquid crystal molecules in the liquid crystal layer 230 can be subject to interaction. Thus, by controlling the arrangement of the different (e.g., shorter) first alignment branches, the same number of singular points S may be produced in each pixel region which, in turn, may promote the display quality of the multi-domain vertical alignment liquid crystal display panel 200.

It should be noted that embodiments are not limited to rectangular shaped first alignment branches nor are the different alignment branches, such as those separated by the distance D1, limited to rectangular shaped branches that are shorter than other first alignment branches. For example, referring to FIG. 4B, the differently formed first alignment branches 216c may be generally rectangular and longer than other first alignment branches 216a. Alternatively, as is shown in FIG. 4C, the first alignment branches 216d may have different length-to-width ratios than those of other first alignment branches 216a. In other words, the first alignment branches may all be generally rectangular, but the branches 216d may be longer with a reduced width as compared to the branches 216a. Moreover, as is shown in FIG. 4D, the alignment branches 216e, which are shown as being separated by distance D1, may have a generally trapezoidal shape. That is, in some embodiments, trapezoidal alignment branches may be integral with the pixel electrode 216. In yet another embodiment, the differently formed first alignment branches have shapes and/or dimensions that differ from each other. For instance, referring to FIG. 4E, one first alignment branch 216f may be longer than another first alignment branch 216f. In other words, in a pair of first alignment branches 216f that face each other, one branch may be longer than the other branch in the pair, in some embodiments. It should be noted, however, that embodiments are not limited to first alignment branches 216f having different lengths as shown in FIG. 4E—other arrangements are contemplated.

Referring to FIG. 3B, in some embodiments, second alignment branches 222a may be formed on the common electrode layer 222 of the opposite substrate 220. Like the first alignment branches on the pixel electrode 216, the second alignment branches on the common electrode layer 222 may face each other to form second jagged slits J2. At least one pair of facing second alignment branches 222b is different from other second alignment branches 222a in form. For example, second alignment branches 222a and 222b may both be generally rectangular, but the second alignment branches 222b may be shorter than second alignment branches 222a, although embodiments are not so limited. That is, at least one pair of second alignment branches 222b may be formed the same as or similar to the first alignment branches 216b, 216c, 216d, 216e, or 216f shown in FIGS. 4A-4E. In particular, the second alignment branches 222b may be longer or shorter than the other second alignment branches 222a, or the second alignment branches 222b may be trapezoidal or another shape. Furthermore, the second alignment branches 222b may have length-width ratios that are different from those of the other second alignment branches 222a. In some instances, each second alignment branch 222b in a facing pair is different in shape and/or size (see, e.g., FIG. 4E). Adjacent pairs of differently configured second alignment branches 222b may be separated by a predetermined distance D2 in some embodiments.

In sum, according to some embodiments of the present invention, a multi-domain vertical alignment liquid crystal display panel may have alignment branches fabricated on the pixel electrode of the active element array substrate. At least one pair of alignment branches has a design that is different from the design of other alignment branches on the pixel electrode. In some embodiments, differently designed alignment branches may be fabricated on only the common electrode layer of the opposite substrate. Of course, in some embodiments, both types of alignment branches can be fabricated on the pixel electrode of the active element array substrate and on the common electrode layer of the opposite substrate, which is not intended to be a limitation. Because the electric field distribution at the differently fabricated alignment branches may cause the liquid crystal molecules to align in a predetermined direction, the location and the number of singular points S may be controlled for enhanced display quality.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A multi-domain vertical alignment liquid crystal display panel, comprising:
a plurality of pixel units formed on an active element array substrate, each pixel unit having an active element and a pixel electrode electrically connected to the active element, the pixel electrode including a plurality of first alignment branches, the plurality of first alignment branches arranged to form pairs that face each other across a gap and arranged to form a plurality of first jagged slits, at least one pair of the facing first alignment branches configured differently from the other pairs of facing first alignment branches;
a common electrode layer formed on an opposite substrate; and
a liquid crystal layer disposed between the active element array substrate and the opposite substrate.

2. The multi-domain vertical alignment liquid crystal display panel of claim 1, including a predictable number and location of singular points, the number and location of the singular points based, at least in part, on the arrangement of the at least one pair of facing first alignment branches that is configured differently.

3. The multi-domain vertical alignment liquid crystal display panel of claim 1, wherein each alignment branch of the at least one pair of facing first alignment branches that is configured differently has a length that differs from the alignment branches of the other pairs of facing first alignment branches.

4. The multi-domain vertical alignment liquid crystal display panel of claim 1, wherein the alignment branches of the at least one pair of facing first alignment branches that is configured differently have length-to-width ratios that are different from those of the other pairs of facing first alignment branches.

5. The multi-domain vertical alignment liquid crystal display panel of claim 1, wherein each alignment branch in the at least one pair of facing first alignment branches that is configured differently is generally trapezoidal.

6. The multi-domain vertical alignment liquid crystal display panel of claim 1, including at least two pairs of facing first alignment branches that are configured differently, the at least two pairs separated by a first predetermined distance.

7. The multi-domain vertical alignment liquid crystal display panel of claim 1, wherein one of the first alignment branches in the at least one pair of facing first alignment branches that is configured differently has a length that differs from the other first alignment branch in the at least one pair.

8. The multi-domain vertical alignment liquid crystal display panel of claim 1, wherein a plurality of second alignment branches are formed on the common electrode layer, the plurality of second alignment branches arranged to form pairs that face each other across a gap and arranged to form a plurality of second jagged slits, at least one pair of the facing second alignment branches configured differently from other pairs of facing second alignment branches.

9. The multi-domain vertical alignment liquid crystal display panel of claim 8, including a predictable number and location of singular points, the number and location of the singular points based, at least in part, on the arrangement of the at least one pair of facing second alignment branches that is configured differently.

10. The multi-domain vertical alignment liquid crystal display panel of claim 8, wherein each alignment branch of the at least one pair of facing second alignment branches that is configured differently has a length that differs from the alignment branches of the other pairs of facing second alignment branches.

11. The multi-domain vertical alignment liquid crystal display panel of claim 8, wherein the alignment branches of the at least one pair of facing second alignment branches that is configured differently have length-to-width ratios that are different from those of the other pairs of facing second alignment branches.

12. The multi-domain vertical alignment liquid crystal display panel of claim 8, wherein each alignment branch in the at least one pair of facing second alignment branches that is configured differently is generally trapezoidal.

13. The multi-domain vertical alignment liquid crystal display panel of claim 8, including at least two pairs of facing second alignment branches that are configured differently, the at least two pairs separated by a second predetermined distance.

14. The multi-domain vertical alignment liquid crystal display panel of claim 8, wherein one of the second alignment branches in the at least one pair of facing second alignment branches that is configured differently has a length that differs from the other second alignment branch in the at least one pair.

15. A multi-domain vertical alignment liquid crystal display panel, comprising:
an active element array substrate having a plurality of pixel units disposed thereon, each pixel unit including an active element and a pixel electrode, electrically connected to the active element;
an opposite substrate having a common electrode layer disposed thereon, the common electrode layer including a plurality of alignment branches arranged in two rows that are separated by a gap, the alignment branches in the two rows face each other to form a plurality of jagged slits, at least one pair of facing alignment branches having forms that are different from the forms of other alignment branches in the rows; and
a liquid crystal layer sandwiched between the active element array substrate and the opposite substrate.

16. The multi-domain vertical alignment liquid crystal display panel of claim 15, wherein the liquid crystal layer between the at least one pair of facing alignment branches having different forms causes the multi-domain vertical alignment liquid crystal display panel to display singular points.

17. The multi-domain vertical alignment liquid crystal display panel of claim 15, wherein the alignment branches in the at least one pair of facing alignment branches having different forms have a length that differs from the other alignment branches in the rows.

18. The multi-domain vertical alignment liquid crystal display panel of claim 15, wherein the alignment branches of the at least one pair of facing alignment branches having different forms have length-to-width ratios that are different from the length-to-width ratio of the other alignment branches in the rows.

19. The multi-domain vertical alignment liquid crystal display panel of claim 15, wherein the alignment branches of the at least one pair of facing alignment branches having different forms are generally trapezoidal.

20. The multi-domain vertical alignment liquid crystal display panel of claim 15, wherein each alignment branch in a pair of the at least one pair of facing alignment branches has a form that differs the other alignment branch in the pair.
